(19) United States
(12) Patent Application Publication
(10) Pub. No.: US 2023/0273641 A1
(43) Pub. Date: Aug. 31, 2023

(54) COVER LENS FOR CONSUMER ELECTRONICS DEVICE

(71) Applicant: reMarkable AS, Oslo (NO)

(72) Inventors: Hessel Vink, Oslo (NO); Lars Artun, Oslo (NO); Thong Xuan Nguyen, Oslo (NO)

(21) Appl. No.: 18/114,896

(22) Filed: Feb. 27, 2023

Related U.S. Application Data
(60) Provisional application No. 63/314,500, filed on Feb. 28, 2022.

(51) Int. Cl. G06F 1/16; B32B 17/10

(52) U.S. Cl. CPC G06F 1/1643; B32B 17/10146; B32B 17/10871; B32B 17/10577

(57) ABSTRACT

Embodiments of the invention disclose a method of producing a portable electronic device cover glass. The method comprises providing a portable electronic device cover glass preform of a predefined thickness, for example ranging from 10 micrometers to 600 micrometers, and texturing a surface of the portable electronic device cover glass preform such that said surface is provided with a roughness that simulates the surface of paper in terms of a user's reading experience and writing experience.

### CROSS-REFERENCE TO RELATED APPLICATIONS

This application claims a benefit of, and priority to, U.S. Provisional Patent Application No. 63/314,500, filed Feb. 28, 2023, which is incorporated herein by reference in its entirety.

### FIELD OF DISCLOSURE

The disclosure relates to the field of consumer electronics and more generally to a cover lens for a consumer electronics device.

### BACKGROUND

Conventional touch screen displays of portable electronic devices are provided with slippery cover glasses, for example having a surface roughness of less than 0.01 micrometers (Ra and Rms—ISO 4287:1997). As described herein, “slippery” is understood to be synonymous with the colloquial term “smooth.” Slippery cover glasses have many applications, for example avoiding scratches on the cover glass of smartphones and other tablet devices. However, for some portable electronic devices (e.g., writing tablet devices), it may be desirable to provide a touch screen display with a surface that is suitable for being written on with a tablet writing device (e.g., a stylus or a pen). For example, such a surface may simulate paper or any other surface that is considered desirable for a user to write on with a tablet writing stylus. Other conventional device may have a slight texture, employed for example for the purpose of “Anti-Glare”, “Anti-Reflection,” and/or “Anti-Fingerprint.” However, said textures are not adequate for creating a sufficient paper-like writing experience.

Additionally, because conventional cover glasses for touch screen displays are designed to be smooth and slippery, conventional writing tablets are generally provided with thin films of a roughened polymer on top of the cover glass. The roughened polymer is chosen according to hardness and is adapted with a roughness that makes the cover glass feel like paper and readable in all lighting conditions including outdoors. However, such polymers, however, degrade, wear out, and/or scratch easily. In addition, such polymers add additional thickness and complexity to the portable electronic device. The present disclosure provides an alternative approach to configuring a touch screen display that provides a paper-like reading and writing experience without the employment of a polymer coating.

### SUMMARY

The present disclosure provides a method of producing a portable electronic device cover glass. In one embodiment, the method comprises the steps of providing a portable electronic device cover glass preform and texturing a surface of the portable electronic device cover glass preform with a roughness that simulates the surface of paper in terms of a reading and writing experience. For example, the portable electronic device cover glass preform may have a thickness of maximum 600 micrometers.

In another embodiment, the method comprises the steps of providing a portable electronic device cover glass preform with a thickness of a maximum 600 micrometers and texturing a surface of the portable electronic device cover glass preform such that said surface is provided with a mean roughness, Ra, in the range 0.8 micrometers-1.5 micrometers, a mean spacing of profile elements, Rms, in the range 110 micrometers-190 micrometers, and/or an average profile peak height, Rp, in the range 3.3 micrometers-4.6 micrometers.

The present disclosure further provides a portable electronic device cover glass, the portable electronic device cover glass having a surface that simulates the surface of paper in terms of reading and writing experience. In some embodiments, the portable electronic device cover glass has a mean roughness, Ra, in the range 0.8 micrometers-1.5 micrometers, a mean spacing of profile elements, Rms, in the range 110 micrometers-190 micrometers, and an average profile peak height, Rp, in the range 3.3 micrometers-4.6 micrometers.

The present disclosure further provides a portable electronic device comprising a textured cover glass.

Other advantageous features will be apparent from the accompanying claims.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (or “FIG.”) 1 is an overview of definitions used for roughness parameters herein, according to one example embodiment.

FIG. 2 is another overview of definitions used for roughness parameters herein, according to one example embodiment.

FIG. 3 is a micrograph showing the surface texture of a portable electronic device cover glass, according to one example embodiment.

FIG. 4 is a schematic illustration of a portable electronic device cover glass preform being textured using a mold, according to one example embodiment.

FIG. 5 is a schematic illustration of a mold being provided with a texture, according to one example embodiment,

FIG. 6 schematically illustrates a portable electronic device cover glass provided with a texture suitable for simulating a writing surface for a tablet writing stylus, according to one example embodiment.

FIG. 7 schematically illustrates a portable electronic device provided with a cover glass with a texture suitable for simulating a writing surface for a tablet writing stylus, according to one example embodiment.

FIG. 8 schematically illustrates a portable electronic device cover glass preform being textured by a chemical or physical method, according to one example embodiment.

### DETAILED DESCRIPTION

In the following, general embodiments as well as particular exemplary embodiments of the disclosure will be described. References will be made to the accompanying drawings. It shall be noted, however, that the drawings are exemplary embodiments only, and that other features and embodiments may well be within the scope of the disclosure as claimed. Further, the mentioning of references such as “a” or “an” etc. should not be construed as excluding a plurality.

Unless otherwise defined, all terms of art, notations and other scientific terms or terminology used herein are intended to have the meanings commonly understood by those of skill in the art to which this disclosure pertains. Certain terms of art, notations, and other scientific terms or terminology may, however, be defined specifically as indicated below. Symbols indicating a quantity or parameter may or may not use subscript-notation, i.e., symbols that indicate a quantity such as “Xy” and “X_{y}” may be used interchangeably to refer to the same quantity or parameter.

Embodiments of the invention pertain to a portable electronic device, a portable electronic device cover glass, and a method of producing the portable electronic device cover glass. The portable electronic device and the portable electronic device cover glass may impact both the user's reading experience and the user's writing experience. As described herein, “reading experience” refers to the the overall, holistic impression a user experiences when reading text and or images on a medium, for example the portable electronic device. In particular, the reading experience may refer to a user's experience when reading or viewing text and or images through the portable electronic device's cover glass. Similarly, as described herein, “writing experience” refers to the overall, holistic impression a user's experience when writing with a pen, stylus or other similar input mechanism on a writing surface. Writing experience may further include, but is not limited to, the user's haptic and tactile experience with the portable electronic device, for example when the writing surface comprises the portable electronic device cover glass.

A portable electronic device may according to the present disclose be a smart phone, tablet, writing tablet or a reading tablet, or any other suitable computing device. More particularly, the portable electronic device may be an e ink tablet or an electronic paper tablet. A portable electronic device may comprise a touchscreen display, where the touch screen display comprises a cover glass. As described herein, such a cover glass may be referred to as a portable electronic device cover glass. A portable electronic device cover glass may be included as a component of the touch screen display to protect internal components of the touch screen from mechanical damage and also provide rigidity to the portable electronic device. As will be appreciated by a person skilled in the art, the portable electronic device cover glass may itself be covered by one or more additional materials, for example, a polymer surface for providing a rough touching surface, an anti-scratch cover or any other suitable or similar material.

According to the present disclosure, the portable electronic device cover glass may be any type of glass pane suitable for use as a cover glass of a touch screen display of a portable electronic device. For example, the portable electronic device cover glass may be a cover glass comprising any one or more of aluminosilicate, alkali-aluminosilicate, potassium-aluminosilicate, lithium-aluminosilicate and borosilicate, or a combination thereof. In a particular embodiment of the present disclosure, the portable electronic device cover glass comprises an alkali-aluminosilicate, for example an alkali-aluminosilicate comprising potassium. As will be appreciated by a person skilled in the art, the method of producing a standard plane, or bent portable electronic device cover glass is well known. Alkali-aluminosilicate portable electronic device cover glasses may be produced using any suitable technique including, but not limited to, an ion exchange process. In a particular embodiment involving an ion exchange process, a glass is lowered into a molten potassium salt bath such that sodium ions in the precursor glass are exchanged with potassium.

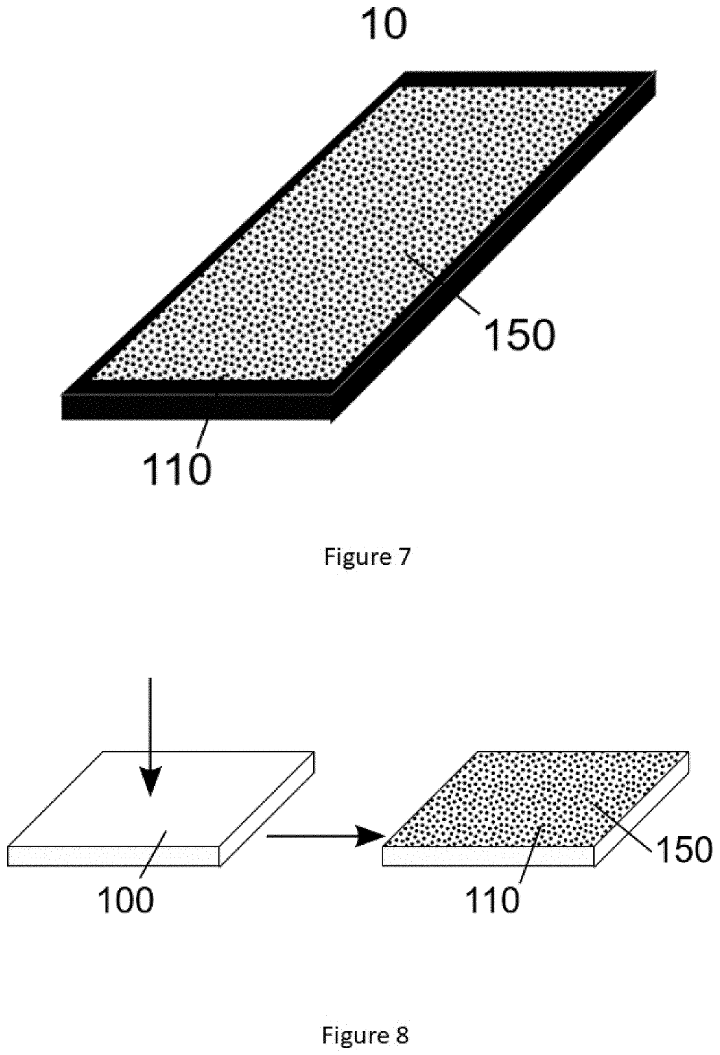

A portable electronic device cover glass 110 may according to the present disclosure be produced with a surface that is suitable for simulating a writing surface for a tablet writing stylus. Thus, the portable electronic device cover glass 110 may be provided with a particular surface texture 150. Said surface texture 150 may be defined by a set of selected roughness parameters determined for obtaining a desirable reading surface and writing surface for a tablet writing stylus. FIG. 6 schematically illustrates a portable electronic device cover glass 110 provided with a texture 150 suitable for simulating a writing surface for a tablet writing stylus, according to one embodiment. FIG. 7 schematically illustrates a portable electronic device 10 provided with a cover glass 110 with a texture 150 suitable for simulating a writing surface for a tablet writing stylus, according to one embodiment.

According to the present disclosure a textured portable electronic device cover glass may be obtained by treating a portable electronic device cover glass preform. As described herein, a portable electronic device cover glass preform may be a plane glass sheet of any composition. For example, the portable electronic device cover glass is shaped according to the size of a touch screen of a portable electronic device with which it is intended to be used. Alternatively, the portable electronic device cover glass preform may be a large glass sheet (e.g., in the order of square decimeters or square meters) that is later be cut into smaller sheets for use as a portable electronic device cover glass (e.g., for a particular portable electronic device). A portable electronic device cover glass preform may generally differ from a portable electronic device cover glass in that the portable electronic device cover glass preform does not have the exact same shape as a portable electronic device cover glass. Accordingly, the portable electronic device cover glass preform may undergo shaping, such as any one or more of bending, cutting, and texturing, to turn the portable electronic device cover glass preform into a portable electronic device cover glass to be used with a portable electronic device. Accordingly, a portable electronic device cover glass preform subjected to any one or more of bending, cutting, and texturing may be described herein as a portable electronic device cover glass. In particular embodiments, the portable electronic device cover glass may be defined as a portable electronic device cover glass preform having undergone at least texturing. As will be appreciated by a person skilled in the art, the portable electronic device cover glass preform may alternatively be employed directly as a portable electronic device cover glass.

The thickness of a portable electronic device cover glass preform may vary but may, in some embodiments, have the same thickness as a typical portable electronic device cover glass. In a particular embodiment, the portable electronic device cover glass preform may be thin, for example, 10 micrometers. Embodiments of such thin portable electronic device cover glass preforms may be used where the display of the tablet device folds or bends. In other embodiments, the portable electronic device cover glass preform is thicker, for example in the range of 200-600 micrometers. In particular embodiments, the thickness of the portable electronic device cover glass preform falls within a more specific range such as 300-500 micrometers. For example, the portable electronic device cover glass preform may have a thickness of 400 micrometers±50 micrometers. In another example, the portable electronic device cover glass preform may have a maximum thickness of 500 micrometers±50 micrometers.

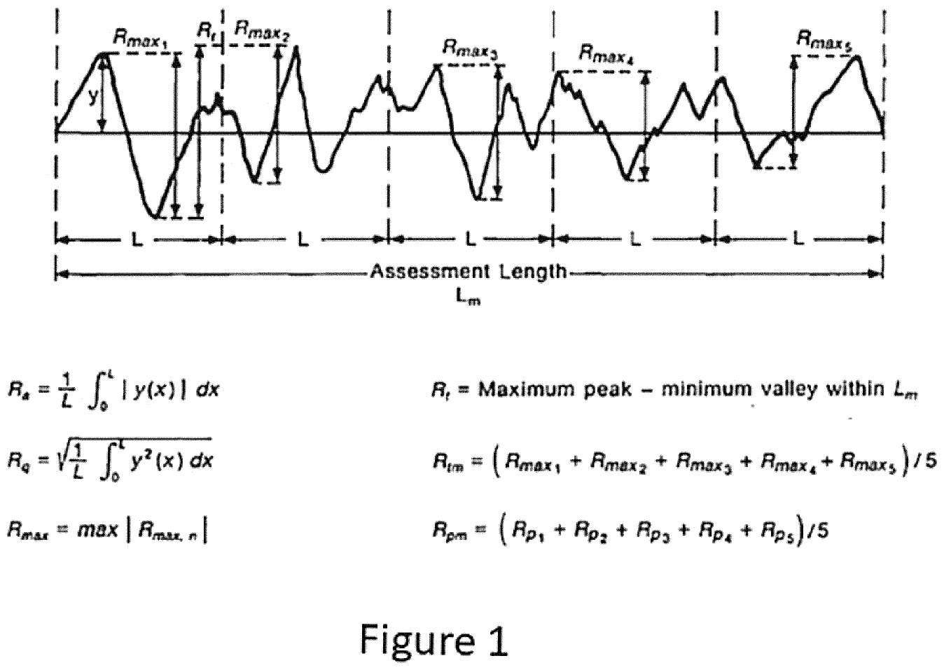

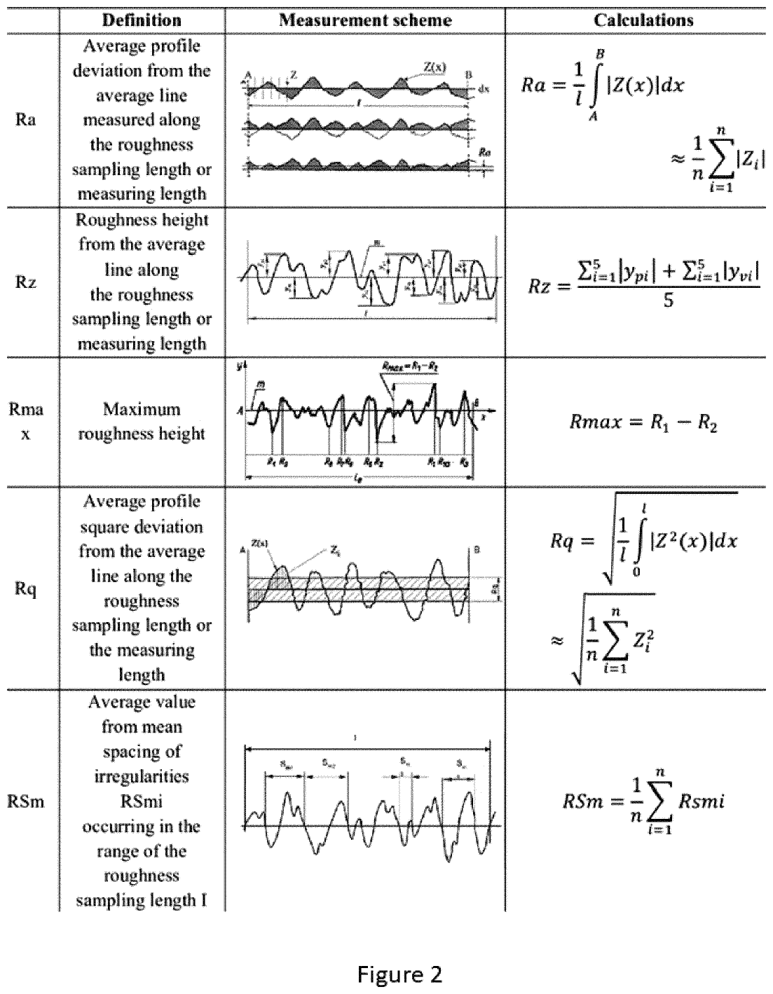

As described herein, texturing of a surface refers to a process for making a surface less flat than the surface was prior to the texturing, for example by introducing deviations such as indents, scratches, etch patterns, or any other suitable technique. Accordingly, texturing may include the roughening of a surface, for example by introducing ordered deviations, non-ordered deviations, or a combination thereof. Surface roughness parameters may generally be employed to quantify the degree of texturing of a surface. Examples of surface roughness parameters include, but are not limited to, the maximum peak to valley height of a measure profile, the peak to valley height of a profile. Surface roughness parameters may be obtained through profile-based measurements (e.g., measurements of a one-dimensional profile). In alternate embodiments, surface roughness parameters may be characterized using 2D definitions of surface roughness. FIGS. 1 and 2 illustrate definitions of roughness parameters employed in one or more embodiments described herein. Definitions for roughness parameters not indicated in FIGS. 1 and 2 are to be interpreted as would be understood by a person having ordinary skill in the art, for example, as defined by ISO 4287:1997. Definitions of a set of roughness parameters are listed below:
Rₜ: Total height of a measured profile, i.e., the maximum peak to valley depth within a measured profile.
Rₜₘ: Mean Rₜ—Average height of a measured profile, i.e., the maximum average peak to valley depth within a measured profile.
Rms: Root mean square roughness.
Rₚ: Maximum peak height above a mean line of a measured profile.
Rₚₘ: Mean Rₚ: Average peak height above a mean line of a measured profile.
RSm: Mean width/spacing of profile elements.

In some embodiments, the roughness parameters Ra, Rsm, and Rₚ are considered to evaluate whether a surface offers a quality writing experience for a tablet writing stylus. The surface of the portable electronic device cover glass preform may be textured such that said surface is provided with one or more of a mean roughness, Ra, for example, in the range 0.8 micrometers-1.5 micrometers, a mean spacing of profile elements, Rms, for example, in the range 110 micrometers-190 micrometers, and an average profile peak height, Rp, for example, in the range 3.3 micrometers-4.6 micrometers. A portable electronic device cover glass as described herein may be employed in any suitable portable electronic device.

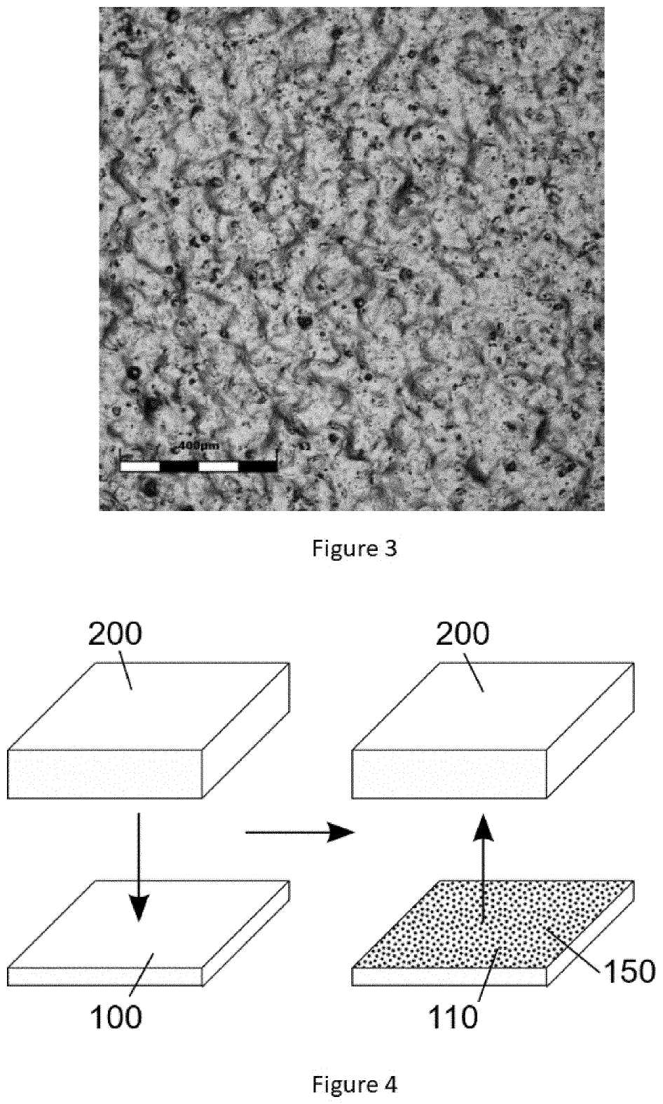

FIG. 3 is a micrograph showing the surface texture of a portable electronic device cover glass, according to one example embodiment.

Texturing of a portable electronic device cover glass preform 100 may be performed using a variety of suitable techniques. A portable electronic device cover glass preform can be textured by a physical treatment, a chemical treatment, hot forming, or any other suitable technique. Physical treatment may include direct laser structuring and media blasting. Chemical treatment may include wet etching and/or dry etching. Hot forming processes may include processes where a portable electronic device cover glass preform 100 is shaped when kept at an elevated temperature (e.g., above the glass transition temperature T_{g}). For example, hot forming may include forming methods that employ molds to transfer a pattern from a mold onto the portable electronic device cover glass preform 100. It will be appreciated that any methods described herein may be combined in order to obtain a desirable texture 150 on a portable electronic device cover glass preform 100, and thus on a portable electronic device cover glass 110. FIG. 8 schematically illustrates a portable electronic device cover glass preform 100 being textured by a chemical or physical method, according to one embodiment.

In one embodiment, texturing of a portable electronic device cover glass preform may be performed via direct treatment of the portable electronic device cover glass preform using a laser. The laser may be employed to directly texture a portable electronic device cover glass preform through ablation and/or formation of melt zones. For example, a femtosecond pulsed laser having a wavelength of 515 nm or 1064 nm and optionally with a frequency >5 MHz may be employed to texture a portable electronic device cover glass perform. In one embodiment, the texturing itself may here be performed using the laser in 1D in a polygon scanner mode (e.g., with a speed v>50 m/s). In some embodiments, the resolution of the laser may be set in the interval from 15-50 micrometers depending on the exact resolution that is desirable to obtain.

In another embodiment, a portable electronic device cover glass preform may be textured by media blasting. The media blasting may be performed at room temperature, or at elevated temperature, for example above the glass transition temperature T_{g}, of the portable electronic device cover glass preform. The media blasting may be performed using any one or more of sand, steel, sodium carbonate, silicon carbide, alumina, slag, glass, dry ice and aluminium silicate, or any other suitable compound as a blasting agent.

In other embodiments, media blasting of the portable electronic device cover glass preform may be preformed using a solution (or slurry or mixture) comprised of a chemical compound (or solute) mixed with (or dissolved in) in a medium (or solvent) like water. For example, a solution or slurry might be formed using water in combination with an appropriate blasting agent, and then the solution or slurry might be delivered to the treatment surface via a high-pressure outlet to increase the effectiveness of the blasting. Once such blasting has been performed, the portable electronic device cover glass preform may be chemically polished.

In yet another embodiment, texturing of a portable electronic device cover glass preform 100 may be performed though hot forming using a mold 200. The portable electronic device cover glass preform 100 may be heated to a softening point (e.g., the glass transition temperature T_{g}) and then pressed by or onto a pre-shaped mold 200 that transfers a texture 150 pattern from the mold 200 onto the portable electronic device cover glass preform 100. The portable electronic device cover glass preform 100 may then be cooled and optionally post treated, for example by a chemical method, to adjust the texture 150 transferred onto the portable electronic device cover glass preform 100 by the mold 200. As is described herein, a mold 200 may be textured with the same, or similar, texture 150 as is desired for the finished portable electronic device cover glass 110. The mold 200 may thus be provided with the same roughness parameters as those previously mentioned herein as preferable for the portable electronic device cover glass preform 100. FIG. 4 is a schematic illustration of a portable electronic device cover glass preform 100 being textured using a mold 200.

Molds for texturing a portable electronic device cover glass preform may be made from a variety of materials, for example steel, graphite, silicon carbide, alumina, quartz, or a combination thereof. As will be appreciated by a person skilled in the art with knowledge of the present disclosure, the exact material used for the mold may depend on the ease of shaping said material and the exact material composition used for the portable electronic device cover glass preform. In some embodiments where the portable electronic device cover glass perform includes an aluminosilicate, graphite may be particularly suitable as a mold.

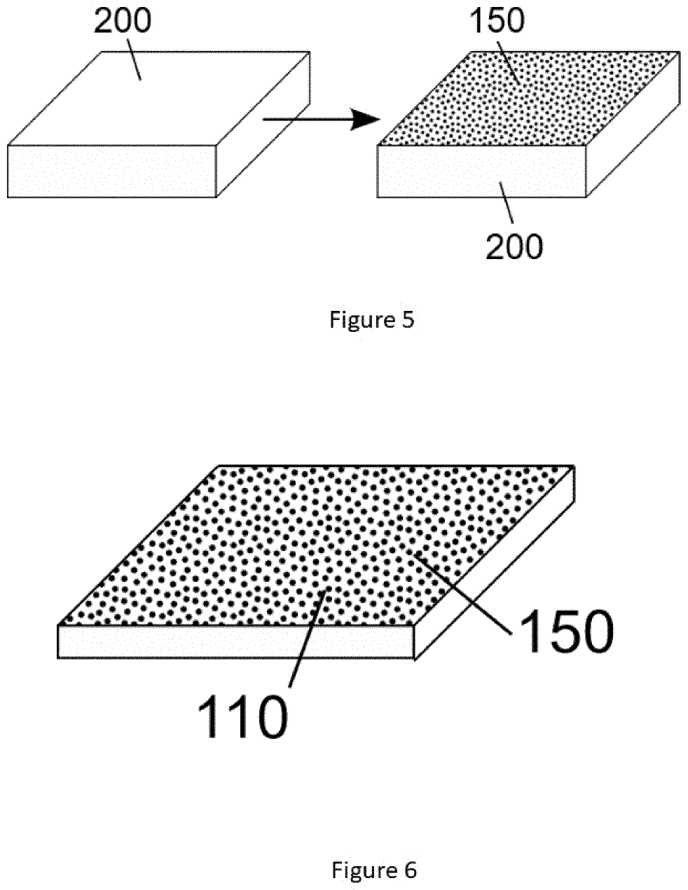

Molds 200 for texturing a portable electronic device cover glass preform may according to the present disclosure be obtained using a wide range of methods. In one embodiment, a mold 200 may be made by means of laser structuring, for example the application of a laser to shape a piece of mold 200 material into a desired shape through laser ablation or melt zone formation. As will be appreciated by a person skilled in the art, said laser structuring of a mold 200 may be performed using a multi-axis setup, for example a 5-axis setup, with a short pulse or ultrashort pulse laser. For example, a Nd:YAG pulsed laser may be used for ablating graphite or steel. FIG. 5 is a schematic illustration of a mold 200 being provided with a texture 150.

In another embodiment, a mold suitable for texturing a portable electronic device cover glass perform may be produced using reactive ion etch, or a deep reactive ion etch. For example, a piece of mold material may be masked (e.g., with a soft mask or a hard mask) to create a pattern on a plane surface of a piece of mold material. During a subsequent reactive ion etch or deep reactive ion etch, the masking may create a tailored texture on the piece of mold material. During such an etching process, the piece of mold material is turned into a mold, which subsequently may be used to transfer the texture pattern on the mold onto a portable electronic device cover glass preform.

In yet another embodiment, a mold suitable for texturing a portable electronic device cover glass preform may be producing using media blasting for texturing a portable electronic device cover glass preform. A mold may be provided by media blasting a piece of mold material using any one or more of sand, steel, sodium carbonate, silicon carbide, alumina, slag, glass, dry ice and aluminium silicate, or combination thereof as a blasting agent. As will be appreciated by a person skilled in the art, a mold may be produced with the same roughness parameters as those previously mentioned herein. Optionally, the mold may additionally be treated with another process (e.g., a chemical process) subsequent to being media blasted, for example to smooth out any rough edges that may have been created by the media blasting, and/or improve important optical parameters.

In yet another embodiment, a mold suitable for texturing a portable electronic device cover glass perform may be produced using electro-discharge machining or electro-chemical machining. Electro-discharge machining or electro-chemical machining may be performed directly on a piece of mold material obtain a textured mold. Use of electro-discharge machining or electro-chemical machining have inter alia been found to produce molds with a high surface quality to be obtained with a high reproducibility.

In yet another embodiment, a mold suitable for texturing a portable electronic device cover glass perform may be produced suing wet chemical etching. For example, the mold may for example comprise a crystalline material (e.g., a single crystal or multi-crystalline material) that may be textured through a wet chemical treatment. The texture may be obtained due to different reactivities between the chemical solution employed and the various crystal planes of the crystal. For example, a silicon single crystal may be employed as a mold where the silicon single crystal has been surface textured by chemical treatment (e.g., by etching with potassium hydroxide). A person skilled in the art will appreciate that other materials, for example quartz, may be textured by chemical treatment, such that the texture comprise a pyramidical texture or similar.

In some embodiments, texturing of a portable electronic device cover glass preform may be performed though direct chemical etching of the portable electronic device cover glass preform. For example, direct chemical etching may be performed using wet chemical etching or dry chemical etching. Examples of dry chemical etching include, but are not limited to, reactive ion etching or deep reactive ion etching.

In some embodiments, wet chemical etching may be employed in order to texture a portable electronic device cover glass preform directly. For example, a solution of hydrofluoric acid may be used, optionally comprising potassium hydroxide. As will be appreciated by a person skilled in the art, the exact chemical solution employed may depend on the exact material used for the portable electronic device cover glass preform. Masking of the portable electronic device cover glass preform may be employed in order to achieve a desirable texture. Typical masks include, but are not limited to, a photoresist mask, a metal hard mask, a silicon-based hard mask, or a combination of a soft mask and a hard mask. The isotropic nature of hydrofluoric etching of glass enables production of a portable electronic device cover glass with smooth surface texture edges.

In one embodiment, reactive ion etching and/or deep reactive ion etching may be employed to texture a portable electronic device cover glass preform directly. For example, the process may employ a mask, e.g., a soft mask or a hard mask, to create a high precision pattern on a plane surface of the piece of mold material. For example, CF4/CHF3 and Argon plasma may be employed. Employed masks may include a photoresist mask or a metal hard mask.

A textured portable electronic device cover glass or cover glass preform may undergo additional treatment subsequent to being textured. For example, a wet chemical etch may be used to smoothen a texture. Alternatively, the texture may be smoothened post treatment using a CO₂ laser. It will be appreciated that any of the aforementioned configurations may be combined to obtain a textured portable electronic device cover glass from portable electronic device cover glass preform.

While particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A method of producing a portable electronic device cover glass, the method comprising:
providing a portable electronic device cover glass preform with a thickness of maximum 600 micrometers, and
texturing a surface of the portable electronic device cover glass preform such that said surface is provided with a roughness that simulates the surface of paper in terms of reading and writing experience.

2. The method of claim 1, where the portable electronic device cover glass preform has a maximum thickness in the range 10 micrometers to 600 micrometers.

3. The method of claim 1, wherein texturing the surface of the portable electronic device cover glass preform comprises texturing of the glass preform using a laser.

4. The method of claim 1, wherein texturing the surface of the portable electronic device cover glass preform comprises texturing of the glass preform through wet chemical etching.

5. The method of claim 1, wherein texturing the surface of the portable electronic device cover glass preform comprises texturing of the glass preform through dry chemical etching.

6. The method of claim 1, wherein texturing the surface of the portable electronic device cover glass preform comprises texturing of the glass preform through media blasting.

7. The method according to any one of the claim 1, wherein texturing the surface of the portable electronic device cover glass preform comprises hot forming of the glass preform with a mold at a temperature above the glass transition temperature, T_{g}, of the portable electronic device cover glass preform.

8. The method according to claim 7, further comprising texturing the mold by one or more of laser structuring, media blasting, reactive ion etching, deep reactive ion etching, wet chemical etching electro-discharge machining and electro-chemical machining.

9. A method of producing a portable electronic device cover glass, the method comprising:
providing a portable electronic device cover glass preform with a thickness of maximum 600 micrometers,
texturing a surface of the portable electronic device cover glass preform such that said surface is provided with a mean roughness, Ra, in the range 0.8 micrometers to 1.5 micrometers,
a mean spacing of profile elements, Rms, in the range 110 micrometers to 190 micrometers, and/or
an average profile peak height, Rp, in the range 3.3 micrometers to 4.6 micrometers.

10. The method of claim 9, where the portable electronic device cover glass preform has a maximum thickness in the range 10 micrometers to 600 micrometers.

11. The method of claim 9, wherein texturing the surface of the portable electronic device cover glass preform comprises texturing of the glass preform using one of the following: a laser, wet chemical etching, dry chemical etching, media blasting.

12. The method according to any one of the claim 9, wherein texturing the surface of the portable electronic device cover glass preform comprises hot forming of the glass preform with a mold at a temperature above the glass transition temperature, T_{g}, of the portable electronic device cover glass preform.

13. The method according to claim 7, further comprising texturing the mold by one or more of laser structuring, media blasting, reactive ion etching, deep reactive ion etching, wet chemical etching electro-discharge machining and electro-chemical machining.

14. A portable electronic device cover glass, the portable electronic device cover glass having
a mean roughness, Ra, in the range 0.8 micrometers to 1.5 micrometers,
a mean spacing of profile elements, Rms, in the range 110 micrometers to 190 micrometers, and
an average profile peak height, Rp, in the range 3.3 micrometers to 4.6 micrometers.

15. A portable electronic device cover glass, the portable electronic device cover glass having a surface that simulates the surface of paper.

16. A portable electronic device cover glass according to claim 14, where the portable electronic device cover glass preform has a maximum thickness in the range 350 micrometers to 450 micrometers.
